(19) United States
(12) Patent Application Publication
(10) Pub. No.: US 2025/0274644 A1
(43) Pub. Date: Aug. 28, 2025

(54) METHOD AND APPARATUS FOR ACQUIRING IMAGE BY USING MULTISPECTRAL SENSOR

(71) Applicants: SAMSUNG ELECTRONICS CO., LTD., Suwon-si (KR); UNIST (ULSANNATIONAL INSTITUTE OF SCIENCE AND TECHNOLOGY), Ulsan (KR)

(72) Inventors: Sangyoon LEE, Suwon-si (KR); Youngshin KWAK, Ulsan (KR); Woo-Shik KIM, Suwon-si (KR); Jisu OHK, Ulsan (KR)

(73) Assignees: SAMSUNG ELECTRONICS CO., LTD., Suwon-si (KR); UNIST (ULSANNATIONAL INSTITUTE OF SCIENCE AND TECHNOLOGY), Suwon-si (KR)

(21) Appl. No.: 19/025,170

(22) Filed: Jan. 16, 2025

(30) Foreign Application Priority Data
Feb. 22, 2024 (KR) 10-2024-0026032

(51) Int. Cl. H04N 23/12; G01J 3/28; H04N 23/71; H04N 23/74; H04N 23/85

(52) U.S. Cl. CPC H04N 23/12; G01J 3/2823; H04N 23/71; H04N 23/74; H04N 23/85; G01J 2003/2826

(57) ABSTRACT

Provided is an image acquisition apparatus including a multispectral image sensor configured to acquire an input image including channel signals corresponding to four or more channels, a memory configured to store at least one instruction, and a processor configured to execute the at least one instruction to determine, based on characteristics of a spectrum of the input image, under which light source group from among a plurality of light source groups a light source of the input image is included in, and color convert the input image based on a color conversion matrix corresponding to the determined light source group, and generate an output image based on the color converted input image.

### CROSS-REFERENCE TO RELATED APPLICATION

This application claims priority to Korean Patent Application No. 10-2024-0026032, filed on Feb. 22, 2024, in the Korean Intellectual Property Office, the disclosure of which is incorporated by reference herein in its entirety.

### BACKGROUND

### 1. Field

Example embodiments of the present disclosure relate to a method and apparatus for acquiring an image by using a multispectral sensor.

### 2. Description of Related Art

For precise restoration of color information of an object after imaging by an image sensor, a process of converting red-green-blue (RGB) of the image sensor into a standard RGB color space or a CIE XYZ color space is required. In this process, as a raw RGB three-channel input needs to be converted into a three-channel output of a standard RGB color space or a CIE XYZ color space, in general, a 3×3 matrix is used for this process. In this regard, as colors may not be precisely restored by using one matrix under various imaging conditions, RGB sensors have been used to improve accuracy of color conversion under various light source conditions by deriving a color conversion matrix optimized for typical standard light sources, such as D65, A, etc. and interpolating the color conversion matrix according to a color temperature of a light source.

In RGB sensors, received light may be divided by three channels. However, multispectral sensors use more channels to divide received light. Accordingly, the spectral characteristics of a light source may be identified in greater detail, and the sensitivity to the light source spectra may be improved. However, RGB sensors having three channels may not be suitable for multispectral sensors including more channels.

### SUMMARY

One or more example embodiments provide a method and apparatus for acquiring an image by using a multispectral sensor, in which an input image of the multispectral sensor is converted into a color space by using a color conversion matrix corresponding to a light source of the time of imaging. The technical objects which the disclosure aims to achieve are not limited to the foregoing, and other technical objects may be inferred from the following embodiments.

Additional aspects will be set forth in part in the description which follows and, in part, will be apparent from the description, or may be learned by practice of example embodiments of the disclosure.

According to an aspect of an example embodiment, there is provided an image acquisition apparatus including a multispectral image sensor configured to acquire an input image including channel signals corresponding to four or more channels, a memory configured to store at least one instruction, and a processor configured to execute the at least one instruction to determine, based on characteristics of a spectrum of the input image, under which light source group from among a plurality of light source groups a light source of the input image is included in, and color convert the input image based on a color conversion matrix corresponding to the determined light source group, and generate an output image based on the color converted input image.

The processor may be further configured to detect a maximum value and a minimum value from among intensity values of the spectrum of the input image, compare a value obtained by dividing the minimum value by the maximum value with a threshold value, determine the light source is included in a first light source group based on the value obtained by dividing the minimum value by the maximum value being greater than or equal to the threshold value, and determine the light source is included in a second light source group based on the value obtained by dividing the minimum value by the maximum value being less than the threshold value.

Based on detecting the maximum value and the minimum value, the processor may be further configured to determine a second greatest intensity value from among the intensity values of the spectrum as the maximum value and determine a second smallest intensity value from among the intensity values of the spectrum as the minimum value to remove noise.

Based on detecting the maximum value and the minimum value, the processor may be further configured to determine the maximum value and the minimum value based on an average of a preset number of values from among the intensity values of the spectrum.

The processor may be further configured to detect a number of peaks included in the spectrum of the input image and wavelength values of the peaks, determine the light source as being included in a first light source group based on no peak being detected, and determine the light source as being included in a second light source group based on the number of peaks corresponding to a preset value.

The processor may be further configured to detect a number of peaks corresponding to a visible region of the spectrum, and determine the light source as a second light source based on at least one peak being detected from a red wavelength, a green wavelength, and a blue wavelength.

For the spectrum of the input image and waveforms of a light source prestored in the memory, the processor may be further configured to determine the spectrum of the input image as one of the waveforms of the light source based on pattern-matching.

The processor may be further configured to detect a white region of the input image based on a Von Kries method based on gray world assumption (GWA).

The processor may be further configured to determine, based on characteristics of a spectrum of the white region, which light source group from among the plurality of light source groups the light source is included in.

The processor may be further configured to optimize the color conversion matrix to minimize a color difference between a color value obtained based on the color conversion matrix and an actual color value.

The processor may be further configured to obtain the color value by converting the channel signals of the input image into spectrum signals and applying a matrix generated based on a CIE color matching function to the spectrum signals.

The output image may have an output value of a standard RGB color space or a CIE XYZ color space.

According to another aspect of an example embodiment, there is provided a method of acquiring an image, the method including acquiring an input image including channel signals corresponding to four or more channels from a multispectral image sensor, based on characteristics of a spectrum of the input image, classifying a light source of the input image to determine under which light source group from among a plurality of light source groups the light source of the input image is included in, and converting colors to generate an output image by color-converting the input image based on a color conversion matrix corresponding to the determined light source group.

The classifying of a light source may include detecting a maximum value and a minimum value from among intensity values of the spectrum of the input image, comparing a value obtained by dividing the minimum value by the maximum value with a preset threshold value, determining the light source as being included in a first light source group based on the value obtained by dividing the minimum value by the maximum value being greater than or equal to the threshold value, and determining the light source as being included in a second light source group based on the value obtained by dividing the minimum value by the maximum value being less than the threshold value.

The classifying of a light source may further include, based on detecting the maximum value and the minimum value, determining a second greatest intensity value from among the intensity values of the spectrum as the maximum value and determining a second smallest intensity value from among the intensity values of the spectrum as the minimum value to remove noise.

The classifying of a light source may further include, based on detecting the maximum value and the minimum value, determining the maximum value and the minimum value through an average of a preset number of values from among the intensity values of the spectrum.

The classifying of a light source may further include detecting a number of peaks included in the spectrum of the input image and wavelength values of the peaks, determining the light source is included in a first light source group when no peak is detected, and determining the light source is included in a second light source group when the number of peaks corresponds to a preset value.

The classifying of a light source may further include detecting a number of peaks corresponding to a visible region of the spectrum, and determining the light source as a second light source when at least one peak is detected from a red wavelength, a green wavelength, and a blue wavelength.

The classifying of a light source may further include, for the spectrum of the input image and waveforms of a light source prestored in a memory, determining the spectrum of the input image as one of the waveforms of the light source through pattern-matching.

The method may further include, prior to the classifying of a light source, detecting a white region of the input image based on a Von Kries method based on gray world assumption (GWA).

### BRIEF DESCRIPTION OF THE DRAWINGS

The above and other aspects, features, and advantages of example embodiments of the disclosure will be more apparent from the following description taken in conjunction with the accompanying drawings, in which:

FIG. 1 is a diagram schematically illustrating a cross-section of a multispectral sensor according to an example embodiment;

FIG. 2 is a block diagram illustrating a schematic structure of an image acquisition apparatus according to an embodiment;

FIG. 3 is a detail block diagram of the image acquisition apparatus of FIG. 2;

FIG. 4 is a diagram showing a wavelength spectrum of a red-green-blue (RGB) sensor;

FIGS. 5 and 6 are diagrams showing wavelength spectra of a multispectral sensor according to example embodiments;

FIG. 7 is a diagram for explaining a process of generating an image per channel based on signals acquired from a plurality of channels of a multispectral sensor according to an example embodiment;

FIG. 8A is a graph showing a spectrum distribution of a D64 standard light source; FIG. 8B is a graph showing a spectrum distribution of an RGB light-emitting diode (LED) light source;

FIG. 9A is a graph showing output values obtained by measuring the D65 standard light source of FIG. 8A by using a multispectral sensor including 16 channels; FIG. 9B is a graph showing output values obtained by measuring the RGB LED light source of FIG. 8B by using a multispectral sensor including 16 channels;

FIG. 10 is a diagram for explaining a process of optimizing a color conversion matrix, according to an example embodiment;

FIG. 11 is a flowchart showing a method of acquiring an image, according to an example embodiment;

FIG. 12 is a block diagram illustrating a schematic structure of an electronic device according to an example embodiment;

FIG. 13 is a block diagram schematically illustrating a camera module provided in the electronic device of FIG. 12; and

FIGS. 14, 15, 16, 17, 18, 19, 20, 21, 22, and 23 are diagrams showing various examples of an electronic device employing a multispectral sensor according to some example embodiments.

### DETAILED DESCRIPTION

Reference will now be made in detail to embodiments, examples of which are illustrated in the accompanying drawings, wherein like reference numerals refer to like elements throughout. In this regard, the example embodiments may have different forms and should not be construed as being limited to the descriptions set forth herein. Accordingly, the example embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

General terms which are currently used widely have been selected for use in consideration of theirs functions in embodiments; however, such terms may be changed according to an intention of a person skilled in the art, precedents, advent of new technologies, etc. Further, in certain cases, terms have been arbitrarily selected, and in such cases, meanings of the terms will be described in detail in corresponding descriptions. Accordingly, the terms used in the embodiments should be defined based on their meanings and overall descriptions of the embodiments, not simply by their names.

In some descriptions of the embodiments, when a portion is described as being connected to another portion, the portion may be connected directly to another portion, or electrically connected to another portion with an intervening portion therebetween. When a portion “includes” an element, another element may be further included, rather than excluding the existence of the other element, unless otherwise described.

The terms “comprise” or “include” used in the embodiments should not be construed as including all components or operations described in the specification, and may be understood as not including some of the components or operations, or further including additional components or operations.

The descriptions of the following embodiments should not be construed as limiting the scope of rights, and matters that those skilled in the art can easily derive should be construed as being included in the scope of rights of the embodiments. Hereinafter, embodiments will be described in detail as an example, with reference to the attached drawings.

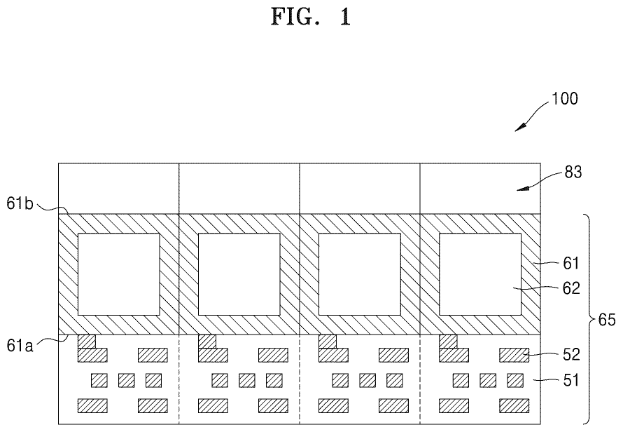

FIG. 1 is a diagram schematically illustrating a cross-section of a multispectral sensor according to an example embodiment.

A multispectral sensor 100 illustrated in FIG. 1 may include, for example, a complementary metal oxide semiconductor (CMOS) image sensor or a charge coupled device (CCD) image sensor.

With reference to FIG. 1, the multispectral sensor 100 may include a pixel array 65 and a spectral filter 83 arranged on the pixel array 65. Here, the pixel array 65 may include a plurality of pixels arranged in a two-dimensional (2D) manner, and the spectral filter 83 may include a plurality of resonators arranged to respectively correspond to the plurality of pixels. FIG. 1 illustrates an example in which the pixel array 65 includes four pixels and the spectral filter 83 includes four resonators.

Each pixel of the pixel array 65 may include a photodiode 62, which is a photoelectric transformation element, and a driver circuit 52 configured to drive the photodiode 62. The photodiode 62 may be buried in a semiconductor substrate 61.

The semiconductor substrate 61 may be, for example, a silicon substrate. However, embodiments are not limited thereto. A wiring layer 51 may be provided on a lower surface 61a of the semiconductor substrate 61, and the driver circuit 52, such as a metal oxide semiconductor field effect transistor (MOSFET), etc. may be provided in the wiring layer 51.

The spectral filter 83 including the plurality of resonators may be provided on an upper surface 61b of the semiconductor substrate 61. Each resonator may be arranged to transmit light of a particular wavelength region (wavelength band). Each resonator may include reflection layers spaced apart from each other and cavities provided between the reflection layers. Each of the reflection layers may include, for example, a metal reflection layer or a Bragg reflection layer. Each cavity may be provided to cause resonance of light of a particular desired wavelength area.

The spectral filter 83 may include one or more functional layers improving the transmittance of light passing through the spectral filter 83 and incident towards to the photodiode 62. The functional layer may include a dielectric layer or a dielectric pattern with adjusted refractive index. Moreover, the functional layer may include, for example, an anti-reflection layer, a condenser lens, a color filter, a short-wavelength absorption filter, or a long-wavelength cutoff filter, etc. However, embodiments are not limited thereto.

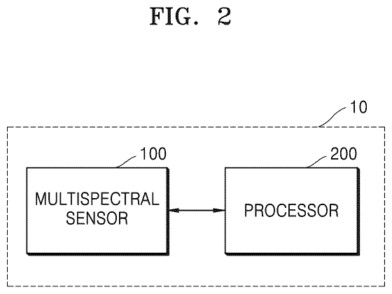

FIG. 2 is a block diagram illustrating a schematic structure of an image acquisition apparatus according to an example embodiment.

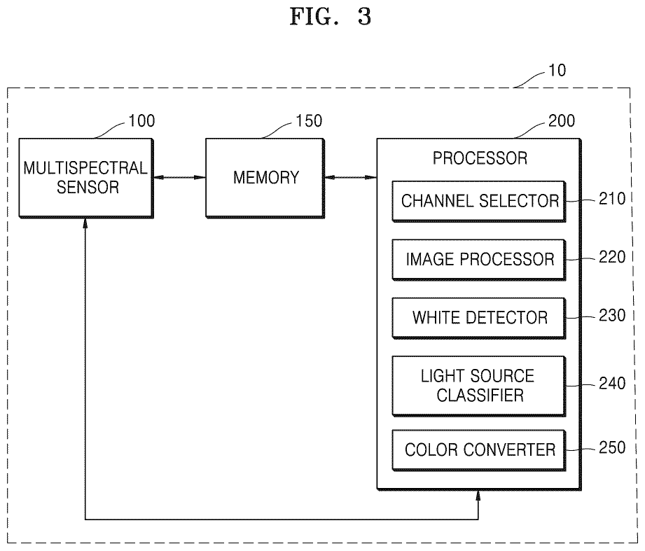

With reference to FIG. 2, an image acquisition apparatus 10 may include the multispectral sensor 100 and a processor 200. The image acquisition apparatus 10 of FIG. 2 only shows the components related to the example embodiments. Accordingly, it is apparent to a person skilled in the art that the image acquisition apparatus 10 may further include other components in addition to the components shown in FIG. 2. For example, the image acquisition apparatus 10 may further include a memory 150, as illustrated in FIG. 3, and may also further include other components in addition to the memory 150.

The multispectral sensor 100 may refer to a sensor configured to sense light having various types of wavelength bands. For example, the multispectral sensor 100 may sense light having more various types of wavelength bands than a red-green-blue (RGB) sensor may sense.

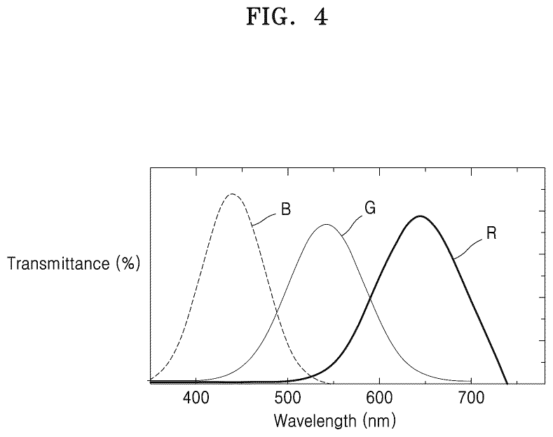

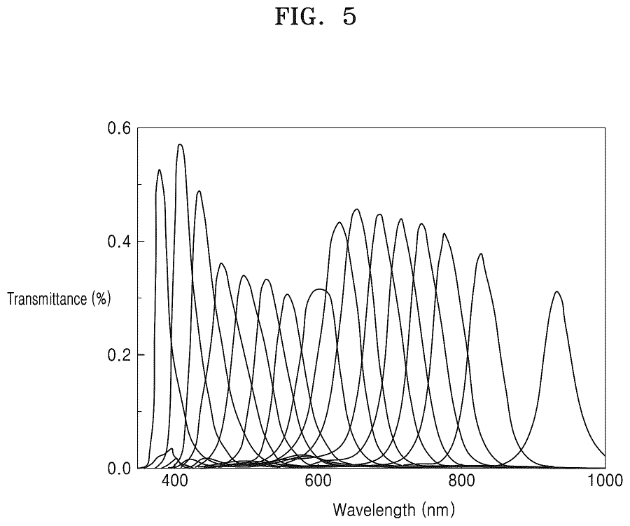

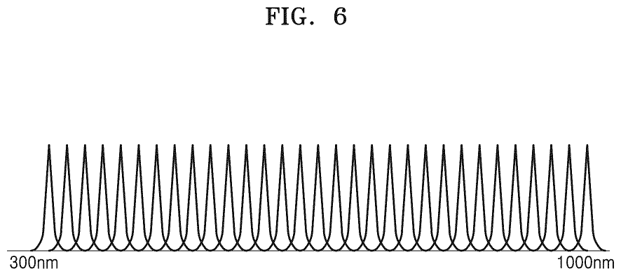

FIG. 4 is a diagram showing wavelength spectrums of an RGB sensor. FIGS. 5 and 6 are diagrams showing wavelength spectrums of a multispectral sensor according to embodiments.

With reference to FIG. 4, an RGB sensor may include an R channel, a G channel, and a B channel, and may sense light of wavelength bands corresponding to each of the three channels. However, embodiments are not limited thereto, and, the multispectral sensor 100 may include 16 channels or 31 channels, as illustrated in FIGS. 5 and 6. However, embodiments are not limited thereto, and the multispectral sensor 100 may include any number of channels as long as the multispectral sensor 100 includes more than four channels.

The multispectral sensor 100 may adjust a center wavelength, a bandwidth, and a transmission amount of light absorbed through each channel so that each channel may sense light of a desired band. For example, a bandwidth of each channel of the multispectral sensor 100 may be narrower than a bandwidth of the R channel, the G channel, and the B channel. Moreover, a whole bandwidth obtained by summing all bandwidths of all channels of the multispectral sensor 100 may include a whole bandwidth of the RGB sensor, and may be wider than the whole bandwidth of the RGB sensor. An image acquired by the multispectral sensor 100 may be a multispectral or hyperspectral image. The multispectral sensor 100 may obtain an image by dividing a relatively wide wavelength band including a visible ray band, an infrared band, and an ultraviolet band into a plurality of channels.

The processor 200 may control all operations of the image acquisition apparatus 10. The processor 200 may include one processor core (a single-core) or a plurality of processor cores (a multi-core). The processor 200 may process or execute instructions, programs, and data stored in a memory. For example, the processor 200 may control functions of the image acquisition apparatus 10 by executing the instructions stored in the memory.

The processor 200 may acquire from the multispectral sensor 100 an input image including channel signals corresponding to four or more channels, and based on characteristics of a spectrum of the input image, the processor 200 may determine under which light source group from among a plurality of light source groups a light source of the input image falls. The processor 200 may generate an output image by color-converting the input image by using a color conversion matrix corresponding to the determined light source group. Hereinafter, the image acquisition apparatus 10 is described in more detail with reference to FIG. 3.

FIG. 3 is a detail block diagram of the image acquisition apparatus 10 of FIG. 2.

With reference to FIG. 3, the image acquisition apparatus 10 may further include the memory 150 in addition to the multispectral sensor 100 and a processor 200. In addition, the processor 200 may include a channel selector 210, an image processor 220, a white detector 230, a light source classifier 240, and a color converter 250. For convenience in explanation, the channel selector 210, the image processor 220, the white detector 230, the light source classifier 240, and the color converter 250 are distinguished from each other according to an operation of the processor 200; however, the units may not be physically separated. For example, the aforementioned units may be a combination of hardware and/or software included in the processor 200, and may be physically the same as or different from each other.

The memory 150 may refer to hardware storing various types of data processed by the image acquisition apparatus 10, and for example, the memory 150 may store an image (or signal) obtained from the multispectral sensor 100. The memory 150 may be a line memory sequentially storing images on a line basis, and may be a frame buffer storing an entire image. Furthermore, the memory 150 may store applications, drivers, etc. to be run by the image acquisition apparatus 10. The memory 150 may include random access memory (RAM), such as dynamic random access memory (DRAM) and static random access memory (SRAM), read-only memory (ROM), electrically erasable programmable read-only memory (EEPROM), a CD-ROM, a Blu-ray disc, or other optical disc storages, a hard disk drive (HDD), a solid state drive (SSD), or flash memory. However, embodiments are not limited thereto.

The memory 150 may be arranged outside the multispectral sensor 100 and may be integrated inside the multispectral sensor 100. When the memory 150 is integrated inside the multispectral sensor 100, the memory 150 may be integrated along with a circuit portion (e.g., the wiring layer 51 and/or driver circuit 52 described with reference to FIG. 1.) A pixel portion (e.g., the semiconductor substrate 61 and/or the photodiode 62 described with reference to FIG. 1) and the remaining portion (i.e., the circuit portion and the memory 150) may respectively be a stack, and a total of two stacks may be integrated. In this case, the multispectral sensor 100 may include a single chip including two stacks. However, embodiments are not limited thereto, and the multispectral sensor 100 may be implemented as three stacks having the pixel portion, the circuit portion, and the memory 150.

The circuit portion included in the multispectral sensor 100 may be the same as or different from the processor 200. When the circuit portion included in the multispectral sensor 100 may be identical to the processor 200, the image acquisition apparatus 10 may be the multispectral sensor 100 implemented as an on-chip. Furthermore, even when the circuit portion included in the multispectral sensor 100 is different from the processor 200, when the processor 200 is arranged inside the multispectral sensor 100, the image acquisition apparatus 10 may be implemented as an on-chip. However, embodiments are not limited thereto, and the processor 200 may be separately arranged outside the multispectral sensor 100.

The channel selector 210 may obtain an input image including channel signals corresponding to more than four channels from the multispectral sensor 100. The channel selector 210 may select at least some of a certain number of channels physically provided at the multispectral sensor 100 and acquire the channel signals from the selected channels. For example, the channel selector 210 may obtain channel signals from all of the certain number of channels physically provided at the multispectral sensor 100. Moreover, the channel selector 210 may obtain channel signals by selecting only some of the certain number of channels physically provided at the multispectral sensor 100.

The channel selector 210 may acquire an increased or reduced number of channel signals, which are more or less than a certain number of channel signals, by synthesizing or interpolating channel signals acquired from the certain number of channels physically provided at the multispectral sensor 100. For example, the channel selector 210 may obtain a reduced number of channel signals, which are less than a certain number of channel signals, by performing binning on the pixels or channels of the multispectral sensor 100. Moreover, the channel selector 210 may obtain an increased number of channel signals, which are more than a certain number of channel signals, by generating new channel signals through interpolation of the channel signals.

When the number of acquired channel signals is decreased, each of the channel signals may be of a wide band, the sensitivity of the signals may be increased, and the noise may be reduced. When the number of acquired channel signals is increased, the sensitivity of each channel signal may be slightly decreased, but a more accurate image may be obtained based on the numerous channel signals. As such, as there is a trade-off according to an increase or decrease of the acquired channel signals, the channel selector 210 may obtain a proper number of channel signals according to an application of the channel selector 210.

The image processor 220 may perform basic image processing before or after an input image or a signal obtained by the multispectral sensor 100 is stored in the memory 150. The basic image processing may include bad pixel correction, fixed pattern noise correction, crosstalk reduction, remosaicing, demosaicing, false color reduction, denoising, chromatic aberration correction, etc.

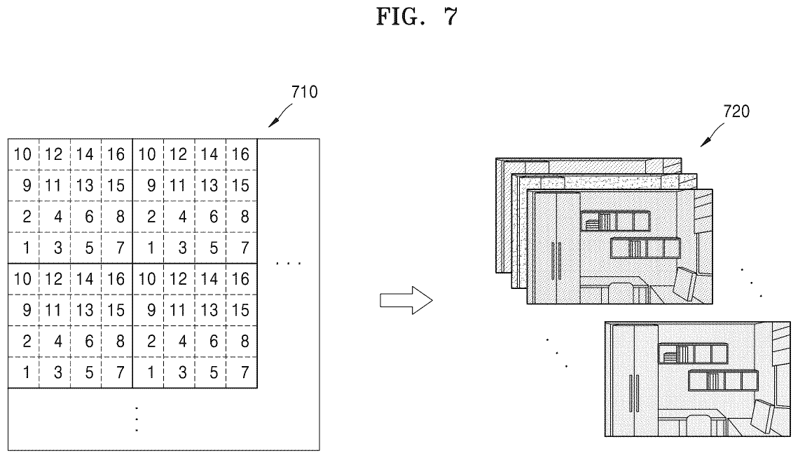

For example, the image processor 220 may generate an image per channel by performing demosaicing on the channel signals, and perform image processing on the image per channel. Hereinafter, the process of demosaicing performed by the image processor 220 is described with reference to FIG. 7.

FIG. 7 is a diagram for explaining a process of generating an image per channel based on signals acquired from a plurality of channels of a multispectral sensor according to an example embodiment.

FIG. 7 illustrates a raw image 710 obtained from the multispectral sensor and an image per channel 720 after the demosaicing. In the raw image 710, one small quadrangle represents one pixel, and the number in the quadrangle represents a channel number. As understood from the channel number, FIG. 7 illustrates an image obtained from the multispectral sensor including 16 channels. Although the raw image 710 includes all pixels of different channels, as pixels of same channels are gathered though the demosaicing, the image per channel 720 may be generated.

Referring back to FIG. 3, the white detector 230 according to an example embodiment may detect a white region in the input image to obtain light source information of the time of photographing the object by using the multispectral sensor 100.

The white detector 230 may detect a white region by using a white balance method. The Von Kries method which is based on gray world assumption (GWA) may be used for white balance. The GWA refers to a theory that every existing colors combine to be an achromatic color and teaches that when an image includes various colors, the overall average of the image is an achromatic color. In this regard, achromatic colors only have brightness but not color components, which indicates that RGB channels have the same average. By the Von Kries method based on GWA, the channels may have the same average.

For example, the white detector 230 may calculate (obtain) an average value for each channel with respect to a sensor signal of the entire input image on the premise that the average color of the entire input image is an achromatic color according to the Von Kries method based on the GWA or find a pixel having the greatest average sensor signal among channels in the input image and calculate (obtain) an average value of certain peripheral regions thereof to find an achromatic color region of the input image and extract the brightest achromatic color region as a white point (or white region).

According to another example embodiment, the image acquisition apparatus 10 may further include an additional sensor separate from the multispectral sensor 100 to obtain light source information (or white region). For example, the additional sensor may be a spectrometer.

The light source classifier 240 according to an example embodiment may determine, based on the characteristics of the spectrum of the input image obtained by the multispectral sensor 100, under which light source group from among the plurality of light source groups the light source of the input image falls.

In this regard, the input image may be an image corresponding to the white region extracted by the white detector 230 (or the additional sensor).

The light source classifier 240 may identify the characteristics of the spectrum based on a signal from the multispectral sensor 100 and classify the light source of the input image into one of preset light source groups. In this regards, the number of the preset light source groups may use a predetermined value according to the number of spectrum characteristics to be classified. For example, the number of the preset light source groups may use a predetermined value according to the number of light sources to be classified.

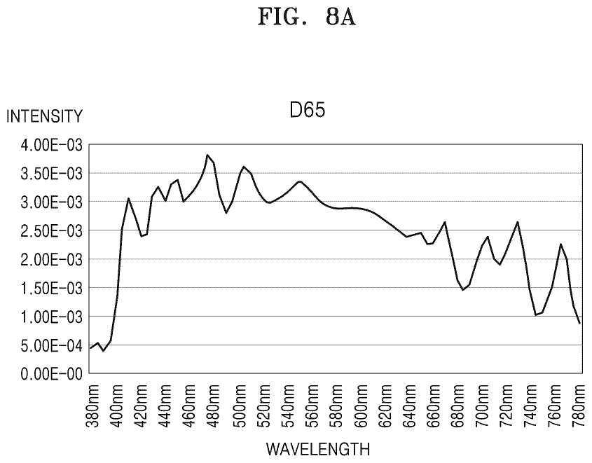

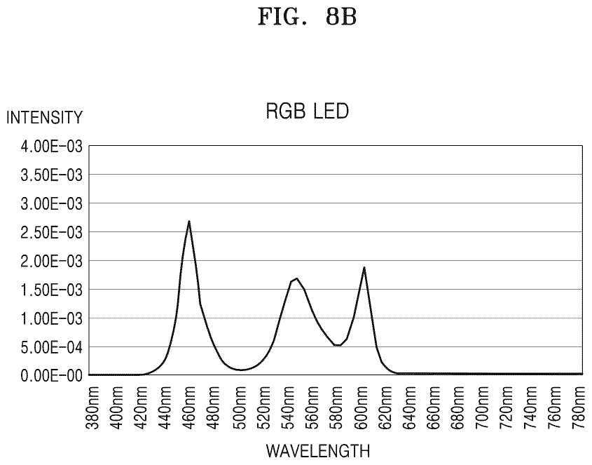

When the number of preset light source groups increases, the color conversion accuracy may be improved but the operation processing time and required memory size may increase. When the number of preset light source groups is limited to two, the color conversion accuracy may slightly decrease while the operation processing time and required memory size may be reduced significantly. As such, there may be a trade-off according to an increase or decrease in the number of preset light source groups. Hereafter, referring to FIGS. 8A and 8B, to clearly show the differences of light source groups, the light source classifier 240 is described on the premise that the number of the preset light source groups is 2.

FIG. 8A is a graph showing a spectrum distribution of a D64 standard light source. FIG. 8B is a graph showing a spectrum distribution of an RGB light-emitting diode (LED) light source. Referring to FIG. 8A, D65 is a standard light source defined by the international commission on illumination (CIE) and has been used as a light source having a color temperatures of about 6,500 [K] and representing average sun light of northern sky. The spectrum of D65 has a generally uniform distribution in which the light intensity rapidly increases up to a wavelength of 380 nm to 460 nm and gradually decreases until a wavelength of 460 nm to 780 nm and is most dominant at light blue. The standard light source representing the day light may further include D50 representing sun light at noon and having a color temperature of about 5,000 [K], D75 representing sun light of northern sky on a clear day and having a color temperature of about 7,500 [K], etc.

The light source classifier 240 may classify the light source emitting light at all wavelength ranges such as the spectrum of D65 illustrated in FIG. 8A into a first light source group. For example, the first light source group may be a light source emitting light and heat through blackbody radiation (i.e., a phenomenon in which an object which achieves a heat equilibrium at a certain temperature emits heat only by radiation). For example, from among the standard light sources defined by the CIE, the standard light source A may be included in the first light source group. The standard light source A refers to light emitted from a perfect radiator, that is about 2,856 [K] and has a distribution in which the light intensity increases linearly at a wavelength of about 380 nm to about 780 nm. The standard light source A may be used to indicate a color of an object lighted by an incandescent light bulb.

Referring to FIG. 8B, the spectrum of the RGB LED light source may have a distribution having a peak value at a wavelength of about 460 nm, about 550 nm, and about 610 nm. The wavelength of about 460 nm may correspond to light blue, the wavelength of about 550 nm may correspond to green, and the wavelength of about 610 nm may correspond to red.

The light source classifier 240 may classify the light source emitting light at some wavelength ranges like the spectrum of RGB LED illustrated in FIG. 8B into a second light source group. The second light source group may be a light source which mainly emits only light unlike the first light source group which emits light and heat. For example, a daylight fluorescent lamp which emits light at a particular wavelength band while having the same color temperature as D65 which is included in the first light source group, a display light source having a peak value at RGB regions (e.g., OLED and LCD), etc. may be included in the second light source group.

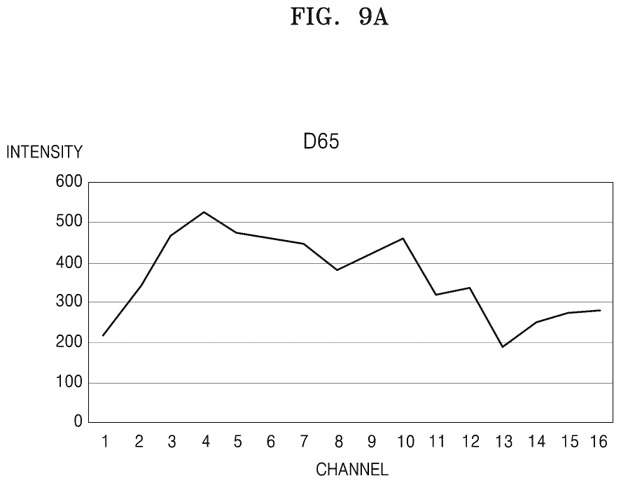

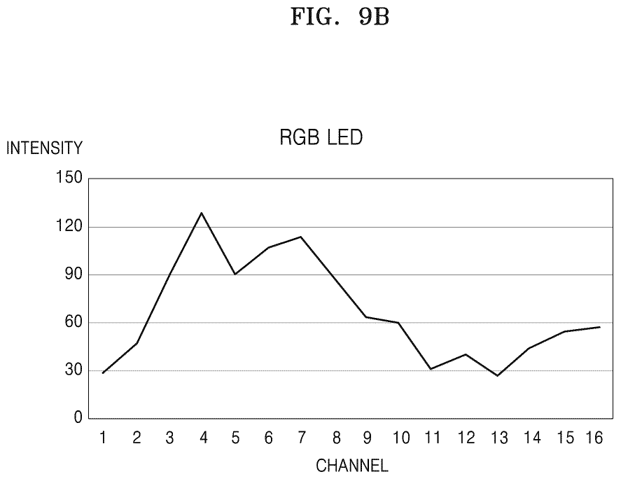

Hereinafter, the light source classifier 240 and a specific method of classifying the light source of the input image are described in relation to FIGS. 9A and 9B.

FIG. 9A is a graph showing output values obtained by measuring the D65 standard light source of FIG. 8A by using a multispectral sensor including 16 channels. FIG. 9B is a graph showing output values obtained by measuring the RGB LED light source of FIG. 8B by using a multispectral sensor including 16 channels.

Referring to FIGS. 9A and 9B, the light source classifier 240 according to an example embodiment may detect a maximum value and a minimum value from among intensity values of the spectrum of the input image acquired by the multispectral sensor 100. By comparing a value obtained by dividing the minimum value by the maximum value with a preset threshold value, when the value obtained by dividing the minimum value by the maximum value is greater than or equal to the threshold value, the light source classifier 240 may determine the light source of the input image as being included in the first light source group and when the value obtained by dividing the minimum value by the maximum value is less than the threshold value, the light source classifier 240 may determine light source of the input image as being included in the second light source group. In this regard, the threshold value may be a value which may distinguish the first light source group and the second light source group from each other and may be determined based on experimental statistics.

For example, the threshold value may be preset to be 0.3. In FIG. 9A, the maximum value of the spectrum of D65 is about 505, and the minimum value is about 200. Thus, the value obtained by dividing the minimum value by the maximum value is about 0.4. As the value obtained by dividing the minimum value by the maximum value is 0.4 which is greater than or equal to the threshold value of 0.3, the light source classifier 240 may determine the light source of the input image as being included in the first light source group.

In FIG. 9B, the maximum value of the spectrum of RGB LED is about 130, and the minimum value is about 28. Thus, the value obtained by dividing the minimum value by the maximum value is about 0.21. As the value obtained by dividing the minimum value by the maximum value is 0.21 which is less than the threshold value of 0.3, the light source classifier 240 may determine the light source of the input image as being included in the second light source group.

When detecting the maximum value and the minimum value of the spectrum of the input value, the light source classifier 240 may determine a second greatest intensity value (or peak value) from among the intensity values of the spectrum as the maximum value and determine a second smallest intensity value (or peak value) from among the intensity values of the spectrum as the minimum value to remove noise.

For example, when the preset threshold value is 0.3, the second maximum value of the spectrum of D65 shown in FIG. 9A is about 450, and the second minimum value is about 310. Thus, the value obtained by dividing the second minimum value by the second maximum value is about 0.69. As the value obtained by dividing the second minimum value by the second maximum value is 0.69 which is greater than or equal to the threshold value of 0.3, the light source classifier 240 may determine the light source of the input image as being included in the first light source group.

In FIG. 9B, the second maximum value of the spectrum of RGB LED is about 110, and the second minimum value is about 30. Thus, the value obtained by dividing the second minimum value by the second maximum value is about 0.27. As the value obtained by dividing the second minimum value by the second maximum value is 0.27 which is less than the threshold value of 0.3, the light source classifier 240 may determine the light source of the input image as being included in the second light source group.

When detecting the maximum value and the minimum value of the spectrum of the input image, the light source classifier 240 may determine the maximum value and the minimum value through an average of the preset number of values (e.g., peak values) from among the intensity values of the spectrum.

For example, when the preset number to obtain an average value is 2, the maximum value average of the spectrum of D65 shown in FIG. 9A is about 477.5, and the second minimum value average is about 255. Thus, the value obtained by dividing the minimum value average by the maximum value average is about 0.53. As the value obtained by dividing the minimum value average by the maximum value average is 0.53 which is greater than or equal to the threshold value of 0.3, the light source classifier 240 may determine the light source of the input image as being included in the first light source group.

In FIG. 9B, the maximum value average of the spectrum of RGB LED is about 120, and the minimum value average is about 29. Thus, the value obtained by dividing the minimum value average by the maximum value average is about 0.24. As the value obtained by dividing the minimum value average by the maximum value average is 0.24 which is less than the threshold value of 0.3, the light source classifier 240 may determine the light source of the input image as being included in the second light source group.

According to an example embodiment, the light source classifier 240 may detect the number of peaks included in the spectrum of the input image and wavelength values (or wavelength bands) of the peaks, determine the light source of the input image as being included in the first light source group when no peak is detected, and determine the light source of the input image as being included in the second light source group when the number of peaks corresponds to a preset value (e.g., 1 to 3).

In addition, the light source classifier 240 may detect the number of peaks corresponding to a visible region of the spectrum and determine the light source of the input image as a second light source when at least one peak is detected from a red wavelength, a green wavelength, and a blue wavelength. For example, the light source classifier 240 may determine the light source of the input image as the second light source when there is one peak at least one of the red wavelength, the green wavelength, and the blue wavelength, when there is one peak at each of the red and green wavelengths, the red and blue wavelengths, and the green and blue wavelengths, and when there is one peak at each of the red wavelength, the green wavelength, and the blue wavelength.

In this regard, when calculating the number of peaks included in the spectrum, the criteria for identification of a peak may be more limited than the criteria used when calculating a maximum value and a minimum value of the spectrum. For example, when calculating a maximum value and a minimum value of the spectrum, based on the peak criteria, a peak may only need to satisfy the condition of gradients of two adjacent sensor values (or intensities) changing from positive to negative, whereas when calculating the number of peaks included in the spectrum, peaks may be counted only in the visible region (that is, between Channels 3 to 11 in FIGS. 9A and 9B), and the peaks may need to satisfy the condition of gradients of two adjacent sensor values (or intensities) changing from positive to negative and the condition of gradient absolute value greater than a preset value.

Both graphs of FIGS. 9A and 9B seem to have peaks as the two graphs are on different scales of sensor values (or intensities) from each other for convenience; however, when the two graphs are on the same scale (or normalized), the spectrum of D65 shown in FIG. 9A may not have a peak, and the spectrum of RGB LED shown in FIG. 9B may have a peak at each channel corresponding to each RGB region.

Accordingly, as the spectrum of D65 shown in FIG. 9A does not have a peak, the light source classifier 240 may determine that the light source of the input image is included in the first light source group, and as the spectrum of RGB LED shown in FIG. 9B has three peaks, the light source classifier 240 may determine that the light source of the input image is included in the second light source group.

In another example embodiment, by pattern-matching waveforms of a predetermined light source and the spectrum of the input image, the light source classifier 240 may classify the input spectrum into one of the waveforms of the preset light source.

The light source classifier 240 according to another example embodiment may input the spectrum of the input image to a pretrained neural network and classify a light source by using an output value of the neural network. The neural network may have an architecture of a deep neural network (DNN) or n-layers neural networks. The DNN or n-layers neural networks may be convolutional neural networks (CNN), recurrent neural networks (RNN), deep belief networks, restricted Boltzmann machines, residual neural networks (Resnet), etc. However, embodiments are not limited thereto, and the neural networks may have various architectures.

Referring back to FIG. 3, the color converter 250 according to an example embodiment may generate an output image by color-converting the input image by using a color conversion matrix corresponding to a light source group classified by the light source classifier 240.

In this regard, the output image may have an output value of a standard RGB color space or a CIE XYZ color space. The standard RGB color space may be a standard RGB (sRGB) color space or an adobe RGB color space used in monitors, printers, or internet. The CIE XYZ color space may show RGB tristimulus values as XYZ, which is another set of tristimulus values all of which are positive values.

The color converter 250 according to an example embodiment may convert N channel signals C₁ to C_{N} (or input image) into a CIE XYZ color space by using a precalculate (obtain)d 3×N matrix Mc optimized to each light source group (e.g., the first light source group and the second light source group). For example, the color converter 250 may convert the channel signals according to the following Equation 1:

$$[ \begin{matrix}{X}_{predict} \\ {Y}_{predict} \\ {Z}_{predict}\end{matrix} ] = {M}_{c} \cdot [ \begin{matrix}{C}_{1} \\ ⋮ \\ {C}_{N}\end{matrix} ] . \qquad [ Equation 1 ]$$

Then, the color converter 250 may convert an XYZ signal into a standard RGB color space by using a determinant defined by each standard. For example, when the input image is to be converted into a sRGB standard color space, the color converter 250 may obtain an sRGB signal according to Equation 2. In Equation 2, M_{sRGB} represents a determinant defined in the sRGB standard color space.

$$[ \begin{matrix}{R}_{s} \\ {G}_{s} \\ {B}_{s}\end{matrix} ] = {M}_{sRGB} \cdot {M}_{c} \cdot [ \begin{matrix}{C}_{1} \\ ⋮ \\ {C}_{N}\end{matrix} ] \qquad [ Equation 2 ]$$

The color conversion matrix Mc may be calculate (obtain)d by using a method minimizing a color difference based on results of measuring or imaging test colors under various light source conditions, a method restoring a spectrum, a matrix R method in which weighted values are applied to the spectrum restoration method or the minimum color difference method and aggregated, etc.

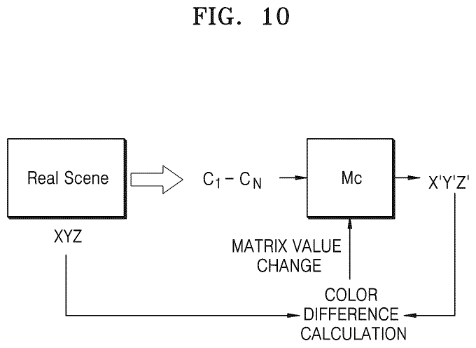

For example, the color converter 250 may optimize the color conversion matrix so that a color difference between a color value obtained by using a color conversion matrix corresponding to a light source group and an actual color value is minimized. Hereinafter, the process of optimizing the color conversion matrix is described with reference to FIG. 10.

FIG. 10 is a diagram for explaining a process of optimizing a color conversion matrix, according to an example embodiment.

As a real scene is photographed under various light source conditions by the multispectral sensor 100 (FIG. 3), a plurality of channels signals C₁ to C_{N} may be obtained. When an initial color conversion matrix M_{c} is applied to the plurality of channel signals C₁ to C_{N}, a predicted color value X′Y′Z′ may be obtained. By using a formula, such as CIELAB or CIEDE2000, a color difference between an actual color value XYZ corresponding to a real scene and the predicted color value X′Y′Z′ may be calculate (obtain)d. To minimize the color difference calculate (obtain)d by using an optimization algorithm, elements of the color conversion matrix M_{c} may be changed. As the foregoing process is repeated, the color conversion matrix may be optimized to be able to more accurately output an actual color value when the channel signals are input.

Table 1 shows, in terms of CIEDE2000 color difference, comparison in color conversion quality between the case where two color conversion matrixes optimized in correspondence to respective light source groups are used and the case where only one color conversion matrix is used.

TABLE 1

| | CIEDE2000 color | | |
|---|---|---|---|
| | difference | D65 | RGB LED |
| Light source | Average of 9 colors | 1.96 | 2.56 |
| classification not | Maximum value of 9 | 3.14 | 4.76 |
| applied | colors | | |
| | Average of white | 1.90 | 2.59 |
| | color | | |
| Light source | Average of 9 colors | 1.44 | 2.14 |
| classification applied | Maximum value of 9 | 2.23 | 4.19 |
| | colors | | |
| | Average of white | 1.34 | 1.23 |
| | color | | |

Referring to Table 1, the channel signal of the multispectral sensor 100 was converted into a CIE XYZ value through the color conversion matrix and then converted into a CIELAB value based on XYZ=[475 500 545] for calculation. For each light source group (e.g., the first light source group (D65) and the second light source group (RGB LED)), Table 1 shows the results for the central eight colors of the chromatic color series and the white color of the achromatic color series of the 24-color Macbeth color chart.

When a light source that emits light from the entire region, such as the D65 standard light source, is referred to as the first light source group, a light source that emits light only from a certain region, such as the RGB LED light source, is referred to as the second light source group, and the color conversion is performed without classification, the average color difference of CIEDE2000 may be calculate (obtain)d as 1.96 for the D65 standard light source and 2.56 for the RGB LED light source. When a color conversion matrix corresponding to a classified light source group is applied, the D65 standard light source has an average color difference of 1.44, and the RGB LED light source has an average color difference of 2.14. For example, when a color conversion matrix corresponding to a light source group is used, a color difference may decrease, compared to the case where one color conversion matrix is used for color conversion.

Similarly, as for each of the maximum value and the white color average of 9 colors, when a color conversion matrix corresponding to a light source group is used, a color difference may decrease, compared to the case where one color conversion matrix is used for color conversion.

As such, when a color conversion matrix optimized to a light source group (e.g., the first light source group and the second light source group) is applied, the color conversion accuracy of the image acquisition apparatus 10 (FIG. 3) may be improved.

In addition, the color converter 250 (FIG. 3) may perform the color conversion based on spectrum restoration. For example, as shown in the following Equation 3, the color converter 250 may first convert the channel signals into a spectrum signal by using a matrix Mₛ, and then obtain the color value XYZ by applying a matrix CMF generated based on a CIE color matching function.

$${M}_{c} \cdot [ \begin{matrix}{C}_{1} \\ ⋮ \\ {C}_{N}\end{matrix} ] = CMF \cdot {M}_{s} \cdot [ \begin{matrix}{C}_{1} \\ ⋮ \\ {C}_{N}\end{matrix} ] \qquad [ Equation 3 ]$$

In Equation 3, the matrix CMF may be 3×L. Here, 3 indicates that the matrix CMF has three wavelengths, i.e., X, Y, and Z, and L represents a sampling number for the wavelengths. In Equation 3, the matrix Mₛ may be L×N.

The matrix Mₛ may have a relation with a matrix T including spectrum information corresponding to n test colors and a channel signal matrix C measured with respect to the n test color by using the multispectral sensor, according to the following Equation 4.

$$T = {M}_{s} C \qquad [ Equation 4 ]$$

Accordingly, the matrix Mₛ may be calculate (obtain)d by using a pseudo-inverse matrix, as shown in the following Equation 5.

$$[ Equation 5 ]$$

$${M}_{s} = T \cdot PINV ( C ) = [ \begin{matrix}{T}_{1 , 1} & ⋯ & {T}_{1 , n} \\ ⋮ & ⋱ & ⋮ \\ {T}_{L , 1} & ⋯ & {T}_{L , n}\end{matrix} ] \cdot PINV [ \begin{matrix}{C}_{1 , 1} & ⋯ & {C}_{1 , n} \\ ⋮ & ⋱ & ⋮ \\ {C}_{N , 1} & ⋯ & {C}_{N , n}\end{matrix} ]$$

N channel signals may be converted into a spectrum signal by the matrix Mₛ. Even though specific values of the spectrum signals are slightly different, the predicted color value may be identical. Accordingly, when the color conversion is performed at a spectrum signal level by using an optimized matrix Mₛ, a more accurate color value may be obtained. The optimization of the matrix Mₛ may be performed in a similar manner as described with reference to FIG. 10. However, embodiments are not limited thereto.

The color converter 250 according to another example embodiment may perform the color conversion by using a neural network. In this case, neural networks optimized and trained for respective light source groups may be used. An input to a neural network may be a signal value of each channel of the multispectral sensor, and an output value may be a value of a conversion target color space, such as X, Y, Z, or R, G, B. The neural network may have an architecture of a deep neural network (DNN) or n-layers neural networks. The DNN or n-layers neural networks may be convolutional neural networks (CNN), recurrent neural networks (RNN), deep belief networks, restricted Boltzmann machines, residual neural networks (Resnet), etc. However, embodiments are not limited thereto, and the neural networks may have various architectures.

FIG. 11 is a flowchart showing a method of acquiring an image, according to an example embodiment.

With reference to FIG. 11, a method of acquiring an image, according to the example embodiment, may include operations processed by the image acquisition apparatus 10 of FIGS. 2 and 3. Therefore, even though some descriptions are omitted below, when such descriptions have been provided above in relation to FIGS. 1 to 10, they may be applied to the method of acquiring an image illustrated in FIG. 11.

Referring to FIGS. 1 to 11, the method of acquiring an image according to an example embodiment may include acquiring an input image including channel signals corresponding to four or more channels from a multispectral image sensor 100 (operation S10), based on characteristics of a spectrum of the input image, classifying a light source to determine under which light source group from among a plurality of light source groups a light source of the input image falls (operations S20, S30, and S31), and converting a color to generate an output image by color-converting the input image by using a color conversion matrix corresponding to the determined light source group (operations S40 and S41).

In operation S10, the image acquisition apparatus 10 may obtain an input image including channel signals corresponding to more than four channels from the multispectral sensor 100. In an example embodiment, the channel selector 210 of the image acquisition apparatus 10 may select at least some of the preset number of channels physically provided in the multispectral sensor 100 and obtain channel signals from the selected channels. In another embodiment, the image processor 220 of the image acquisition apparatus 10 may obtain more or less channel signals than the certain number of channels by combining or interpolating the channel signals obtained from the certain number of channels provided in the multispectral sensor 100.

In addition, the white detector 230 of the image acquisition apparatus 10 may detect a white region in the input image to obtain light source information of the time of photographing the object by using the multispectral sensor 100. For example, the white detector 230 may calculate (obtain) an average value for each channel with respect to a sensor signal of the entire input image on the premise that the average color of the entire input image is an achromatic color according to the Von Kries method based on the GWA or find a pixel having the greatest average sensor signal among channels in the input image and calculate (obtain) an average value of certain peripheral regions thereof to find an achromatic color region of the input image and extract the brightest achromatic color region as a white point (or white region).

According to another example embodiment, the image acquisition apparatus 10 may further include an additional sensor separate from the multispectral sensor 100 to obtain light source information (or white region). For example, the additional sensor may be a spectrometer.

In operation S20, the light source classifier 240 of the image acquisition apparatus 10 may determine, based on the characteristics of the spectrum of the input image obtained by the multispectral sensor 100, which light source group from among the plurality of light source groups the light source of the input image is included in. In this regard, the input image may be an image corresponding to the white region extracted by the white detector 230 (or the additional sensor). The light source classifier 240 may identify the characteristics of the spectrum based on a signal from the multispectral sensor 100 and classify the light source of the input image into one of preset light source groups. In this regards, the number of the preset light source groups may use a predetermined value according to the number of spectrum characteristics to be classified. In other words, the number of the preset light source groups may use a predetermined value according to the number of light sources to be classified.

For example, the light source classifier 240 may detect a maximum value and a minimum value from among intensity values of the spectrum of the input image obtained by the multispectral sensor 100 and by comparing a value obtained by dividing the minimum value by the maximum value with a preset threshold value, determine the light source of the input image as being included in the first light source group when the value obtained by dividing the minimum value by the maximum value is greater than or equal to the threshold value (S30) and determine the light source of the input image as being included in the second light source group when the value obtained by dividing the minimum value by the maximum value is less than the threshold value (S31). In this regard, the threshold value may be a value which may distinguish the first light source group and the second light source group from each other and may be determined based on experimental statistics.

According to an example embodiment, when detecting the maximum value and the minimum value of the spectrum of the input value, the light source classifier 240 may determine a second greatest intensity value (or peak value) from among the intensity values of the spectrum as the maximum value and determine a second smallest intensity value (or peak value) from among the intensity values of the spectrum as the minimum value to remove noise.

According to an example embodiment, when detecting the maximum value and the minimum value of the spectrum of the input image, the light source classifier 240 may determine the maximum value and the minimum value through an average of the preset number of values (e.g., peak values) from among the intensity values of the spectrum.

According to an example embodiment, the light source classifier 240 may detect the number of peaks included in the spectrum of the input image and wavelength values (or wavelength bands) of the peaks, determine the light source of the input image as being included in the first light source group when no peak is detected (operation S30), and determine the light source of the input image as being included in the second light source group when the number of peaks corresponds to a preset value (e.g., 1 to 3) (operation S31).

According to an example embodiment, the light source classifier 240 may detect the number of peaks corresponding to a visible region of the spectrum and determine the light source of the input image as a second light source when at least one peak is detected from a red wavelength, a green wavelength, and a blue wavelength (operation S31).

In another example embodiment, by pattern-matching waveforms of a predetermined light source and the spectrum of the input image, the light source classifier 240 may classify the input spectrum into one of the waveforms of the preset light source.

In operations S40 and S41, the color converter 250 of the image acquisition apparatus 10 may convert N channel signals (or input images) C₁ to C_{N} into a CIE XYZ color space by using a precalculate (obtain)d 3×N matrix Mc optimized to each light source group (e.g., the first light source group and the second light source group). Then, the color converter 250 may convert an XYZ signal into a standard RGB color space by using a determinant defined by each standard.

The color conversion matrix Mc may be calculate (obtain)d by using a method minimizing a color difference based on results of measuring or imaging test colors under various light source conditions, a method restoring a spectrum, a matrix R method in which weighted values are applied to the spectrum restoration method or the minimum color difference method and aggregated, etc.

In addition, the aforementioned method of acquiring an image may be recorded on a computer-readable recording medium on which one or more programs including instructions to execute the method are recorded. The computer-readable recording medium may include a hardware device specifically configured to store and execute program instructions, such as magnetic media including a hard disk, a floppy disk, and a magnetic tape, optical media such as a CD-ROM and a DVD, magneto-optical media such as a floptical disk, ROM, RAM, flash memory, etc. The program instructions may include not only machine language code, which is made by a compiler, but high level language code executable by a computer by using an interpreter, etc.

The image acquisition apparatus (e.g., the image acquisition apparatus 10 of FIGS. 2 and 3) may be employed in a high performance optical device or a high performance electronic device. The electronic device may include, for example, smartphones, mobile phones, cellular phones, personal digital assistants (PDA), laptop computers, personal computers (PCs), various portable devices, home appliances, digital cameras, automobiles, Internet of Things (IoT) devices, and other mobile or no-mobile computing devices, but embodiments are not limited thereto.

The electronic device may further include, in addition to the image acquisition apparatus 10, a processor configured to control image sensors provided in the electronic device, for example, an application processor (AP), control a number of hardware or software constituent elements by driving operating systems or application programs through the processor, and perform various data processing and calculations. The processor may further include graphics processing units (GPUs) and/or image signal processors. When the processor includes an image signal processor, an image acquired through an image sensor may be stored and/or output using the processor.

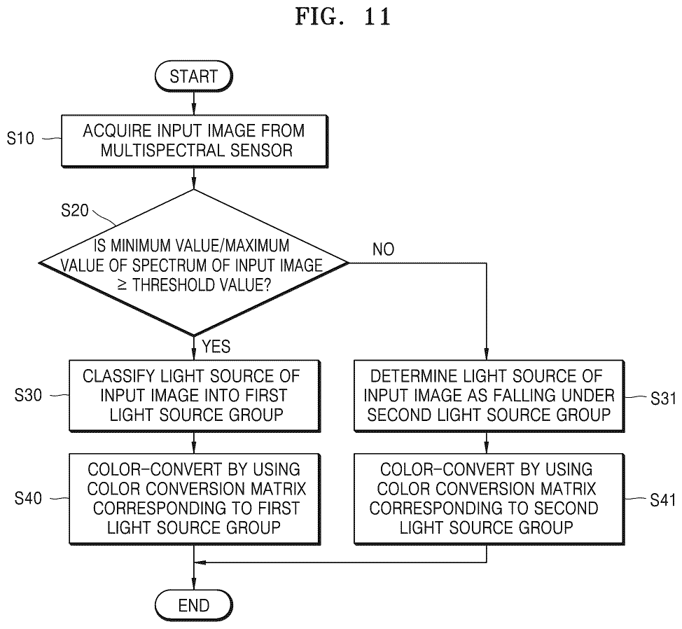

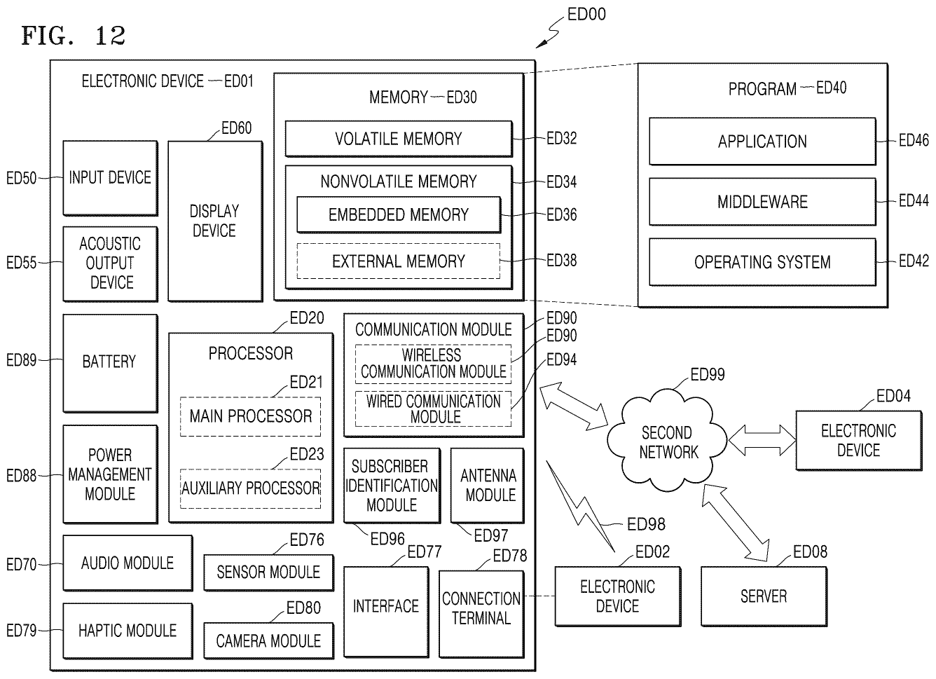

FIG. 12 is a block diagram illustrating a schematic structure of an electronic device according to an example embodiment.

Referring to FIG. 12, in a network environment ED00, the electronic device ED01 may communicate with another electronic device ED02 through a first network ED98 (short-range wireless communication network, and the like), or communicate with another electronic device ED04 and/or a server ED08 through a second network ED99 (long-range wireless communication network, and the like). The electronic device ED01 may communicate with the electronic device ED04 through the server ED08. The electronic device ED01 may include a processor ED20, a memory ED30, an input device ED50, an audio output device ED55, a display device ED60, an audio module ED70, a sensor module ED76, an interface ED77, a haptic module ED79, a camera module ED80, a power management module ED88, a battery ED89, a communication module ED90, a subscriber identification module ED96, and/or an antenna module ED97. In the electronic device ED01, some (the display device ED60, and the like) of constituent elements may be omitted or other constituent elements may be added. Some of the constituent elements may be implemented by one integrated circuit. For example, the sensor module ED76 (a fingerprint sensor, an iris sensor, an illuminance sensor, and the like) may be implemented by being embedded in the display device ED60 (a display, and the like). Furthermore, when the multispectral sensor includes a spectral function, some functions (e.g., a color sensor and an illuminance sensor) of the sensor module ED76 may be implemented by the multispectral sensor, not by a separate sensor module.

The processor ED20 may control one or a plurality of other constituent elements (hardware and software constituent elements, and the like) of the electronic device ED01 connected to the processor ED20 by executing software (a program ED40, and the like), and perform various data processing or calculations. As part of the data processing or calculations, the processor ED20 may load, in a volatile memory ED32, commands and/or data received from other constituent elements (the sensor module ED76, the communication module ED90, and the like), process the command and/or data stored in the volatile memory ED32, and store result data in a non-volatile memory ED34. The processor ED20 may include a main processor ED21 (a central processing unit, an application processor, and the like) and an auxiliary processor ED23 (a graphics processing unit, an image signal processor, a sensor hub processor, a communication processor, and the like) that is operable independently of or together with the main processor ED21. The auxiliary processor ED23 may use less power than the main processor ED21 and may perform a specialized function.

Instead of the main processor ED21 when the main processor ED21 is in an inactive state (sleep state), or with the main processor ED21 when the main processor ED21 is in an active state (application execution state), the auxiliary processor ED23 may control functions and/or states related to some constituent elements (the display device ED60, the sensor module ED76, the communication module ED90, and the like) of the constituent elements of the electronic device ED01. The auxiliary processor ED23 (an image signal processor, a communication processor, and the like) may be implemented as a part of functionally related other constituent elements (the camera module ED80, the communication module ED90, and the like).

The memory ED30 may store various data needed by the constituent elements (the processor ED20, the sensor module ED76, and the like) of the electronic device ED01. The data may include, for example, software (the program ED40, and the like) and input data and/or output data about commands related thereto. The memory ED30 may include the volatile memory ED32 and/or the non-volatile memory ED34. The non-volatile memory ED34 may include an internal memory ED36 fixedly installed in the electronic device ED01 and an external memory ED38 that is removable.

The program ED40 may be stored in the memory ED30 as software, and may include an operating system ED42, middleware ED44, and/or an application ED46.

The input device ED50 may receive commands and/or data to be used for constituent elements (the processor ED20, and the like) of the electronic device ED01, from the outside (a user, and the like) of the electronic device ED01. The input device ED50 may include a microphone, a mouse, a keyboard, and/or a digital pen (a stylus pen, and the like).

The audio output device ED55 may output an audio signal to the outside of the electronic device ED01. The audio output device ED55 may include a speaker and/or a receiver. The speaker may be used for general purposes such as multimedia playback or recording playback, and the receiver can be used to receive incoming calls. The receiver may be implemented by being coupled as a part of the speaker or by an independent separate device.

The display device ED60 may visually provide information to the outside of the electronic device ED01. The display device ED60 may include a display, a hologram device, or a projector, and a control circuit to control a corresponding device. The display device ED60 may include a touch circuitry set to detect a touch and/or a sensor circuit (a pressure sensor, and the like) set to measure the strength of a force generated by the touch.

The audio module ED70 may convert sound into electrical signals or reversely electrical signals into sound. The audio module ED70 may obtain sound through the input device ED50, or output sound through a speaker and/or a headphone of another electronic device (the electronic device ED02, and the like) connected to the audio output device ED55 and/or the electronic device ED01 in a wired or wireless manner.

The sensor module ED76 may detect an operation state (power, temperature, and the like) of the electronic device ED01, or an external environment state (a user state, and the like), and generate an electrical signal and/or a data value corresponding to a detected state. The sensor module ED76 may include a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, and/or an illuminance sensor.

The interface ED77 may support one or a plurality of specified protocols used for the electronic device ED01 to be connected to another electronic device (the electronic device ED02, and the like) in a wired or wireless manner. The interface ED77 may include a high definition multimedia interface (HDMI), a universal serial bus (USB) interface, an SD card interface, and/or an audio interface.

A connection terminal ED78 may include a connector for the electronic device ED01 to be physically connected to another electronic device (the electronic device ED02, and the like). The connection terminal ED78 may include an HDMI connector, a USB connector, an SD card connector, and/or an audio connector (a headphone connector, and the like).

The haptic module ED79 may convert electrical signals into mechanical stimuli (vibrations, movements, and the like) or electrical stimuli that are perceivable by a user through tactile or motor sensations. The haptic module ED79 may include a motor, a piezoelectric device, and/or an electrical stimulation device.

The camera module ED80 may capture a still image and film a video. The camera module ED80 may include the multispectral sensor described above, and may also include additional lens assembly image signal processors and/or flashes. The lens assembly included in the camera module ED80 may collect light emitted from a target object for imaging.

The power management module ED88 may manage power supplied to the electronic device ED01. The power management module ED88 may be implemented as a part of a power management integrated circuit (PMIC).

The battery ED89 may supply power to the constituent elements of the electronic device ED01. The battery ED89 may include non-rechargeable primary cells, rechargeable secondary cells, and/or fuel cells.

The communication module ED90 may establish a wired communication channel and/or a wireless communication channel between the electronic device ED01 and another electronic device (the electronic device ED02, the electronic device ED04, the server ED08, and the like), and support a communication through an established communication channel. The communication module ED90 may be operated independent of the processor ED20 (the application processor, and the like), and may include one or a plurality of communication processors supporting a wired communication and/or a wireless communication. The communication module ED90 may include a wireless communication module ED92 (a cellular communication module, a short-range wireless communication module, a global navigation satellite system (GNSS) communication module, and the like), and/or a wired communication module ED94 (a local area network (LAN) communication module, a power line communication module, and the like). Among the above communication modules, a corresponding communication module may communicate with another electronic device through the first network ED98 (a short-range communication network such as Bluetooth, WiFi Direct, or infrared data association (IrDA)) or the second network ED99 (a long-range communication network such as a cellular network, the Internet, or a computer network (LAN, WAN, and the like)). These various types of communication modules may be integrated into one constituent element (a single chip, and the like), or may be implemented as a plurality of separate constituent elements (multiple chips). The wireless communication module ED92 may verify and authenticate the electronic device ED01 in a communication network such as the first network ED98 and/or the second network ED99 by using subscriber information (an international mobile subscriber identifier (IMSI), and the like) stored in the subscriber identification module ED96.

The antenna module ED97 may transmit signals and/or power to the outside (another electronic device, and the like) or receive signals and/or power from the outside. An antenna may include an emitter formed in a conductive pattern on a substrate (a printed circuit board (PCB), and the like). The antenna module ED97 may include one or a plurality of antennas. When the antenna module ED97 includes a plurality of antennas, the communication module ED90 may select, from among the antennas, an appropriate antenna for a communication method used in a communication network such as the first network ED98 and/or the second network ED99. Signals and/or power may be transmitted or received between the communication module ED90 and another electronic device through the selected antenna. Other parts (an RFIC, and the like) than the antenna may be included as a part of the antenna module ED97.

Some of the constituent elements may be connected to each other through a communication method between peripheral devices (a bus, general purpose input and output (GPIO), a serial peripheral interface (SPI), a mobile industry processor interface (MIPI), and the like) and may mutually exchange signals (commands, data, and the like).

The command or data may be transmitted or received between the electronic device ED01 and the external electronic device ED04 through the server ED08 connected to the second network ED99. The electronic devices ED02 and ED04 may be of a type that is the same as or different from the electronic device ED01. All or a part of operations executed in the electronic device ED01 may be executed in one or a plurality of the electronic devices (ED02, ED04, and ED08). For example, when the electronic device ED01 needs to perform a function or service, the electronic device ED01 may request one or a plurality of electronic devices to perform part of the whole of the function or service, instead of performing the function or service. The one or a plurality of the electronic devices receiving the request may perform additional function or service related to the request, and transmit a result of the performance to the electronic device ED01. To this end, cloud computing, distributed computing, and/or client-server computing technology may be used.

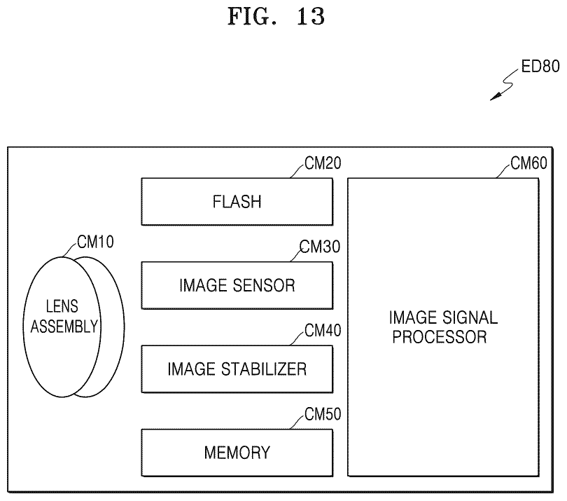

FIG. 13 is a schematic block diagram of a camera module ED80 provided in the electronic device of FIG. 12. The camera module ED80 may include the multispectral sensor described above or have a structure modified therefrom. With reference to FIG. 13, the camera module ED80 may comprise a lens assembly CM10, a flash CM20, an image sensor CM30, an image stabilizer CM40, a memory CM50 (e.g., a buffer memory, etc.), and/or an image signal processor CM60.

The image sensor CM30 may include the multispectral sensor described above. The multispectral sensor may obtain an image corresponding to an object by converting light, which has been emitted or reflected from the object and then transmitted via the lens assembly CM10, into electric signals. The multispectral sensor may obtain a hyperspectral image in an ultraviolet wavelength range or an infrared wavelength range.

The image sensor CM30 may further include one or more sensors selected from image sensors having different attributes, such as another RGB sensor, a black and white (BW) sensor, an infrared (IR) sensor, and an ultraviolet sensor, in addition to the multispectral sensor described above. Each sensor comprised in the image sensor CM30 may be implemented as a charged coupled device (CCD) sensor and/or a complementary metal oxide semiconductor (CMOS) sensor.

The lens assembly CM10 may collect light emitted from a target object for imaging. The camera module ED80 may include a plurality of lens assemblies CM10, and in this case, the camera module ED80 may include a dual camera, a 360 degrees camera, or a spherical camera. Some of the lens assemblies CM10 may have the same lens attributes (a viewing angle, a focal length, auto focus, F Number, optical zoom, and the like), or different lens attributes. The lens assembly CM10 may include a wide angle lens or a telescopic lens.

The lens assembly CM10 may be configured such that two image sensors included in the image sensor CM30 may form an optical phase of an object at the same location and/or may be focus-controlled.

The flash CM20 may emit light used to reinforce light emitted or reflected from an object. The flash CM20 may include one or a plurality of light-emitting diodes (RGB LED, a white LED, an infrared LED, an ultraviolet LED, and the like), and/or a xenon lamp.

The image stabilizer CM40 may move, in response to a movement of the camera module ED80 or an electronic device CM01 including the same, one or a plurality of lenses included in the lens assembly CM10 or a multispectral sensor in a particular direction or may compensate for a negative effect due to the movement by controlling (adjusting a read-out timing and the like) the movement characteristics of the multispectral sensor. The image stabilizer CM40 may detect a movement of the camera module ED80 or the electronic device ED01 by using a gyro sensor (not shown) or an acceleration sensor (not shown) arranged inside or outside the camera module ED80. The image stabilizer CM40 may be implemented in an optical form.

The memory CM50 may store a part or all data of an image obtained through the multispectral sensor for a subsequent image processing operation. For example, when a plurality of images are obtained at high speed, only low resolution images are displayed while the obtained original data (Bayer-Patterned data, high resolution data, and the like) is stored in the memory CM50. Then, the memory CM50 may be used to transmit the original data of a selected (user selection, and the like) image to the image signal processor CM60. The memory CM50 may be incorporated into the memory ED30 of the electronic device ED01, or configured to be an independently operated separate memory.

The image signal processor CM60 may perform image processing on the image obtained through the image sensor CM30 or the image data stored in the memory CM50. Components of a processor 500 for the foregoing may be included in the image signal processor CM60.

The image processing may include depth map generation, three-dimensional modeling, panorama generation, feature point extraction, image synthesis, and/or image compensation (e.g., noise reduction, resolution adjustment, brightness adjustment, blurring, sharpening, softening, etc.) The image signal processor CM60 may perform control (exposure time control, or read-out timing control, and the like) on constituent elements (the image sensor CM30 and the like) included in the camera module ED80. The image processed by the image signal processor CM60 may be stored again in the memory CM50 for additional processing or provided to external constituent elements (e.g., the memory ED30, the display device ED60, the electronic device ED02, the electronic device ED04, the server ED08, etc.) of the camera module ED80. The image signal processor CM60 may be incorporated into the processor ED20, or configured to be a separate processor operated independently of the processor ED20. When the image signal processor CM60 is configured by a separate processor from the processor ED20, the image processed by the image signal processor CM60 may undergo additional image processing by the processor ED20 and then displayed through the display device ED60.

The electronic device ED01 may include a plurality of camera modules ED80 having different attributes or functions. In this case, one of the camera modules ED80 may be a wide angle camera, and another may be a telescopic camera. Similarly, one of the camera modules ED80 may be a front side camera, and another may be a read side camera.

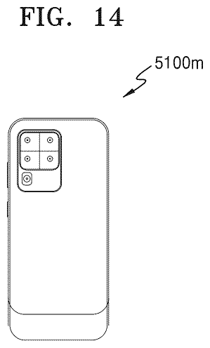

FIGS. 14 to 23 are diagrams showing various examples of an electronic device employing a multispectral sensor according to some example embodiments.

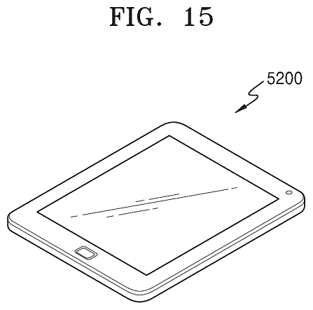

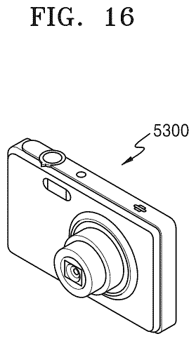

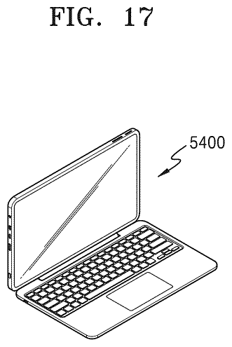

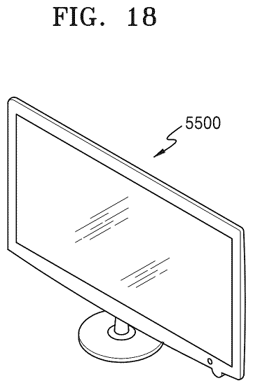

The multispectral sensor may be applied to a mobile phone or a smartphone 5100m illustrated in FIG. 14, a tablet or a smart tablet 5200 illustrated in FIG. 15, a digital camera or a camcorder 5300 illustrated in FIG. 16, a laptop computer 5400 illustrated in FIG. 17, a television or a smart television 5500 illustrated in FIG. 18, etc. For example, the smartphone 5100m or the smart tablet 5200 may include a plurality of high resolution cameras, each having a high resolution image sensor mounted thereon. By using high resolution cameras, depth information of objects in an image may be extracted, out-focusing of the image may be adjusted, or objects in the image may be automatically identified.

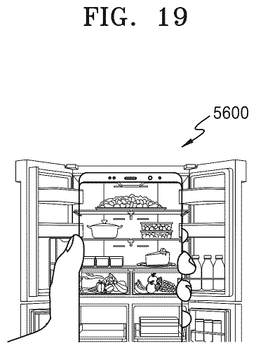

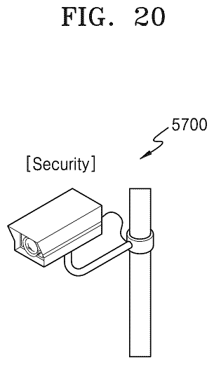

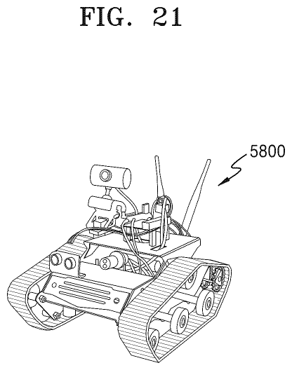

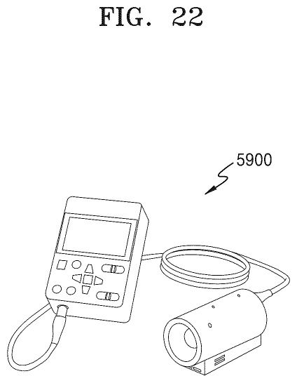

Furthermore, the multispectral sensor may be applied to a smart refrigerator 5600 illustrated in FIG. 19, a security camera 5700 illustrated in FIG. 20, a robot 5800 illustrated in FIG. 21, a medical camera 5900 illustrated in FIG. 22, and the like. For example, the smart refrigerator 5600 may automatically recognize food in a refrigerator, by using the multispectral sensor, and notify a user of the presence of a particular food, the type of food that is input or output, etc., through a smartphone. The security camera 5700 may provide an ultrahigh resolution image and may recognize an object or a person in an image in a dark environment by using high sensitivity. The robot 5800 may be provided in a disaster or industrial site that is not directly accessible by people, and may provide a high resolution image. The medical camera 5900 may provide a high resolution image for diagnosis or surgery, and thus, a field of vision may be dynamically adjusted.

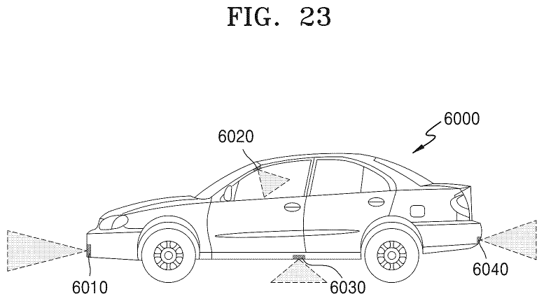

Furthermore, the multispectral sensor may be applied to a vehicle 6000 as illustrated in FIG. 23. The vehicle 6000 may include a plurality of vehicle cameras 6010, 6020, 6030, and 6040 arranged at various positions. Each of the vehicle cameras 6010, 6020, 6030, and 6040 may include the multispectral sensor according to an example embodiment. The vehicle 6000 may provide a driver with various pieces of information about the inside or periphery of the vehicle 6000, by using the vehicle cameras 6010, 6020, 6030, and 6040, and thus, an object or a person in an image may be automatically recognized and information needed for autonomous driving is provided.

The method described above may be recorded on a non-transitory computer-readable recording medium having recorded thereon at least one program including instructions to execute the method. The computer-readable recording medium may include a hardware device specifically configured to store and execute program instructions, such as magnetic media including a hard disk, a floppy disk, and a magnetic tape, optical media such as a CD-ROM and a DVD, magneto-optical media such as a floptical disk, ROM, RAM, flash memory, etc. The program instructions may include not only machine language code, which is made by a compiler, but high level language code executable by a computer by using an interpreter, etc.

According to the image acquisition apparatus and method of the disclosure, by converting an input image of the multispectral sensor into a color space by using a color conversion matrix corresponding to a light source of the time of imaging, the color conversion accuracy may be improved.

It should be understood that example embodiments described herein should be considered in a descriptive sense only and not for purposes of limitation. Descriptions of features or aspects within each example embodiment should typically be considered as available for other similar features or aspects in other embodiments. While example embodiments have been described with reference to the figures, it will be understood by those of ordinary skill in the art that various changes in form and details may be made therein without departing from the spirit and scope as defined by the following claims and their equivalents.

What is claimed is:

1. An image acquisition apparatus comprising:
a multispectral image sensor configured to acquire an input image including channel signals corresponding to four or more channels;
a memory configured to store at least one instruction; and
a processor configured to execute the at least one instruction to:
determine, based on characteristics of a spectrum of the input image, under which light source group from among a plurality of light source groups a light source of the input image is included in; and
color convert the input image based on a color conversion matrix corresponding to the determined light source group; and
generate an output image based on the color converted input image.

2. The image acquisition apparatus of claim 1, wherein the processor is further configured to:
detect a maximum value and a minimum value from among intensity values of the spectrum of the input image;
compare a value obtained by dividing the minimum value by the maximum value with a threshold value;
determine the light source is included in a first light source group based on the value obtained by dividing the minimum value by the maximum value being greater than or equal to the threshold value; and
determine the light source is included in a second light source group based on the value obtained by dividing the minimum value by the maximum value being less than the threshold value.

3. The image acquisition apparatus of claim 2, wherein, based on detecting the maximum value and the minimum value, the processor is further configured to:
determine a second greatest intensity value from among the intensity values of the spectrum as the maximum value and determine a second smallest intensity value from among the intensity values of the spectrum as the minimum value to remove noise.

4. The image acquisition apparatus of claim 2, wherein, based on detecting the maximum value and the minimum value, the processor is further configured to determine the maximum value and the minimum value based on an average of a preset number of values from among the intensity values of the spectrum.

5. The image acquisition apparatus of claim 1, wherein the processor is further configured to:
detect a number of peaks included in the spectrum of the input image and wavelength values of the peaks;
determine the light source as being included in a first light source group based on no peak being detected; and
determine the light source as being included in a second light source group based on the number of peaks corresponding to a preset value.

6. The image acquisition apparatus of claim 5, wherein the processor is further configured to:
detect a number of peaks corresponding to a visible region of the spectrum; and
determine the light source as a second light source based on at least one peak being detected from a red wavelength, a green wavelength, and a blue wavelength.

7. The image acquisition apparatus of claim 1, wherein, for the spectrum of the input image and waveforms of a light source prestored in the memory, the processor is further configured to determine the spectrum of the input image as one of the waveforms of the light source based on pattern-matching.

8. The image acquisition apparatus of claim 1, wherein the processor is further configured to detect a white region of the input image based on a Von Kries method based on gray world assumption (GWA).

9. The image acquisition apparatus of claim 8, wherein the processor is further configured to determine, based on characteristics of a spectrum of the white region, which light source group from among the plurality of light source groups the light source is included in.

10. The image acquisition apparatus of claim 1, wherein the processor is further configured to optimize the color conversion matrix to minimize a color difference between a color value obtained based on the color conversion matrix and an actual color value.

11. The image acquisition apparatus of claim 10, wherein the processor is further configured to obtain the color value by converting the channel signals of the input image into spectrum signals and applying a matrix generated based on a CIE color matching function to the spectrum signals.

12. The image acquisition apparatus of claim 1, wherein the output image has an output value of a standard RGB color space or a CIE XYZ color space.

13. A method of acquiring an image, the method comprising:
acquiring an input image including channel signals corresponding to four or more channels from a multispectral image sensor;
based on characteristics of a spectrum of the input image, classifying a light source of the input image to determine under which light source group from among a plurality of light source groups the light source of the input image is included in; and
converting colors to generate an output image by color-converting the input image based on a color conversion matrix corresponding to the determined light source group.

14. The method of claim 13, wherein the classifying of a light source comprises:
detecting a maximum value and a minimum value from among intensity values of the spectrum of the input image;
comparing a value obtained by dividing the minimum value by the maximum value with a preset threshold value;
determining the light source as being included in a first light source group based on the value obtained by dividing the minimum value by the maximum value being greater than or equal to the threshold value; and
determining the light source as being included in a second light source group based on the value obtained by dividing the minimum value by the maximum value being less than the threshold value.

15. The method of claim 14, wherein the classifying of a light source further comprises, based on detecting the maximum value and the minimum value, determining a second greatest intensity value from among the intensity values of the spectrum as the maximum value and determining a second smallest intensity value from among the intensity values of the spectrum as the minimum value to remove noise.

16. The method of claim 14, wherein the classifying of a light source further comprises, based on detecting the maximum value and the minimum value, determining the maximum value and the minimum value through an average of a preset number of values from among the intensity values of the spectrum.

17. The method of claim 13, wherein the classifying of a light source further comprises:
detecting a number of peaks included in the spectrum of the input image and wavelength values of the peaks;
determining the light source is included in a first light source group when no peak is detected; and
determining the light source is included in a second light source group when the number of peaks corresponds to a preset value.

18. The method of claim 17, wherein the classifying of a light source further comprises:
detecting a number of peaks corresponding to a visible region of the spectrum; and
determining the light source as a second light source when at least one peak is detected from a red wavelength, a green wavelength, and a blue wavelength.

19. The method of claim 13, wherein the classifying of a light source further comprises, for the spectrum of the input image and waveforms of a light source prestored in a memory, determining the spectrum of the input image as one of the waveforms of the light source through pattern-matching.

20. The method of claim 13, further comprising, prior to the classifying of a light source, detecting a white region of the input image based on a Von Kries method based on gray world assumption (GWA).
